(19) United States
(12) Patent Application Publication
(10) Pub. No.: US 2007/0194192 A1
(43) Pub. Date: Aug. 23, 2007

(54) Holding element for gratings

(75) Inventors: Thomas Foser, Balzers (LI); Markus Durig, Gaschurm (AU)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/657,289

(22) Filed: Jan. 23, 2007

(30) Foreign Application Priority Data
Feb. 20, 2006 (DE) 10 2006 008 111.0

(51) Int. Cl. F21V 21/00

(52) U.S. Cl. 248/226.11

(57) ABSTRACT

A holding element for securing gratings (50) to supports (40) includes first leg-shaped engagement part (11), a second engagement part (12), and a connection section for connecting the first (11) and the second (12) engagement parts, with the first and second engagement parts (11, 12) projecting from the connection section and being spaced from each other along a longitudinal axis (L) of the connection section, and with the connection section being formed, at least partially, of a spring element (13) elastically expandable in a direction of the longitudinal axis (L) of the connection section by up to 150% of its initial length (A).

### BACKGROUND OF THE INVENTION

1. Field of the Invention

The present invention relates to a holding element for securing gratings to supports and including a first leg-shaped engagement part, a second engagement part, and a connection section for connecting the first and the second engagement parts, with the first and second engagement parts projecting from the connection section and being spaced from each other along a longitudinal axis of the connection section.

2. Description of the Prior Art

U.S. Pat. No. 4,362,422 discloses a multipart holding element for gratings having a base member, a bracket clamp, and a screw that connects both parts. At one end of the base member, there is provided a pivotal clamp rotatable about an axis and elastically biased in a rotational direction by a spring element. The pivotal clamp is placed on the bottom of the grating, with the end of the base member remote from the pivotal clamp being placed on a support. The bracket clamp is placed on the upper surface of the grating and is secured to the base member with a screw.

The drawback of the holding element of U.S. Pat. No. 4,362,422 lies in the large number of parts and in the costly assembly work.

European Publication EP 0 923 675 B1 discloses a U-shaped hold-down element for a metal grating and which has two opposite legs that project from a connection web. The end of the second leg remote from the connection web is inclined in a direction away from the first leg, whereas the end of the first leg remote from the connection web is inclined toward the second leg. In order to provide a fulcrum during mounting of the hold-down element, a projection adjacent to the second leg is arranged in the proximity of the bent end of the first leg. The projection engages, during mounting of the hold-down element, an edge of a cross-strip of the cell of the metal grating.

The drawback of the disclosed hold-down element consists in that it can be used only for gratings having a predetermined height, so that for different heights of gratings or grating/support combinations, there must be provided different sizes of the holding-down elements with connection sections having different lengths.

The object of the present invention is to provide a holding element in which the foregoing drawbacks are eliminated.

Another object of the present invention is to provide a holding element that can be easily mounted.

### SUMMARY OF THE INVENTION

These and other objects of the present invention, which will become apparent hereinafter, are achieved by providing a holding element of the type described above, and in which the connection section is formed, at least partially, of a spring element elastically expandable in a direction of the longitudinal axis of the connection section by up to 150% of its initial length.

With an elastically expandable spring element, the distance between the two, spaced from each others engagement parts, which are spaced from each other along the longitudinal axis of the connection section and which themselves are deflection-resistant, can be varied by stretching the spring element in the direction of its longitudinal axis. This permits to use the inventive holding element for gratings having different heights. At the same time, the holding element is easily mountable and provides for good holding values.

Advantageously, the spring element has opposite ends secured to first and second connection regions of the, respectively, first and second engagement parts. This feature provides an easily manufacturable holding element the deflection-resistant engagement parts of which are connected by a separate spring element.

It is advantageous when the spring element not only expands from its initial length but is also elastically compressible. The compressibility of the spring element permits to use the holding element for gratings the heights of which are smaller than the distance of the engagement parts from each other along the longitudinal axis of the connection section, and also for gratings the heights of which are equal to the distance between the two parts or greater.

Advantageously, the spring element is expandable in the directions of the longitudinal axis of the connection section by up to 200% of the initial length. The expansion of the spring element up to 200% of its initial length provides for a sufficiently large range of variation of the distances between the two engagement parts. The holding element is further improved by allowing the spring element to compress in the direction of the longitudinal axis by up to 50% of its original length.

Advantageously, the spring element is formed as a wavy leaf spring which has very good spring characteristics for use in the inventive holding element. Further, advantageously, the wavy leaf spring is formed of at least two waves, which insures good expansion and compressibility of the spring element.

It is advantageous when the spring element is deflection-resistant in a direction transverse to the longitudinal axis of the connection section and transverse to a longitudinal axis of the leg-shaped first engagement part. This feature minimizes a side deflection or swinging of the engagement parts with respect to a plane defined by the holding element.

It is further advantageous when the second engagement part has an opening with an abutment for screw means, and the first engagement part has a counter-thread for a thread of the screw means and holding means for securing the holding element on a support and facing in a direction toward the second engagement part. In this way, the holding element can be secured with the screw means to both the grating and the support with high holding values. Thereby, the grating cannot be too easily removed by an unauthorized side either from support or from a grillage.

Advantageously, the first leg-shaped engagement part has a projection formed thereon and extending sidewise of a longitudinal axis of the first leg-shaped engagement part and sidewise of the longitudinal axis of the connection section. The projection serves as a stop of the first engagement part for the grating, which permits to achieve a desired clamping effect.

The novel features of the present invention, which are considered as characteristic for the invention, are set forth in the appended claims. The invention itself, however, both as to its construction and its mode of operation, together with additional advantages and objects thereof, will be best understood from the following detailed description of the preferred embodiment, when read with reference to the accompanying drawings.

### BRIEF DESCRIPTION OF THE DRAWINGS

The drawings show:

FIG. 1 a perspective view of a holding element according to the present invention; and

FIG. 2 a side cross-sectional view of the holding element in a condition in which it is secured on a grating and on a support.

### DETAILED DESCRIPTION OF THE PREFERRED EMBODIMENT

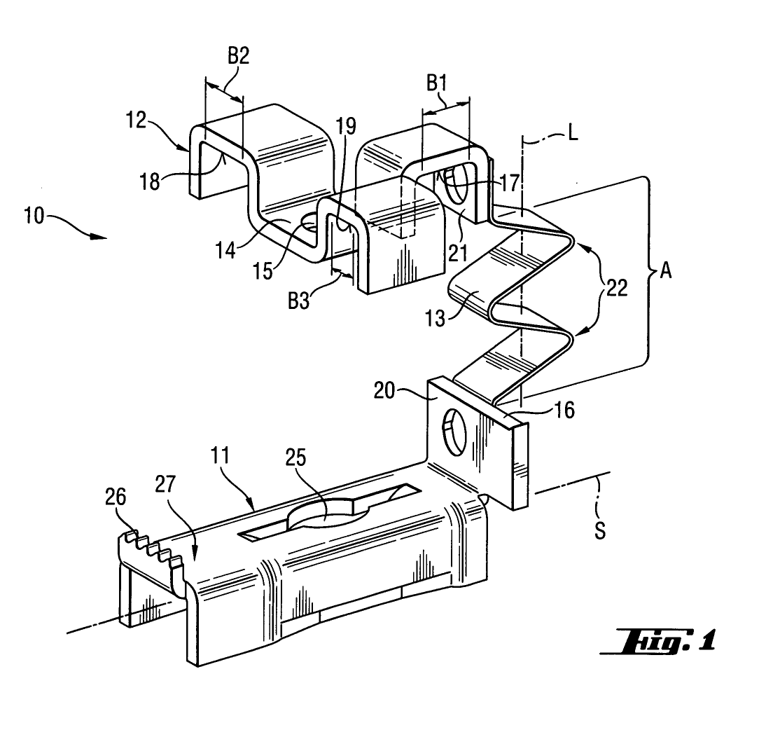

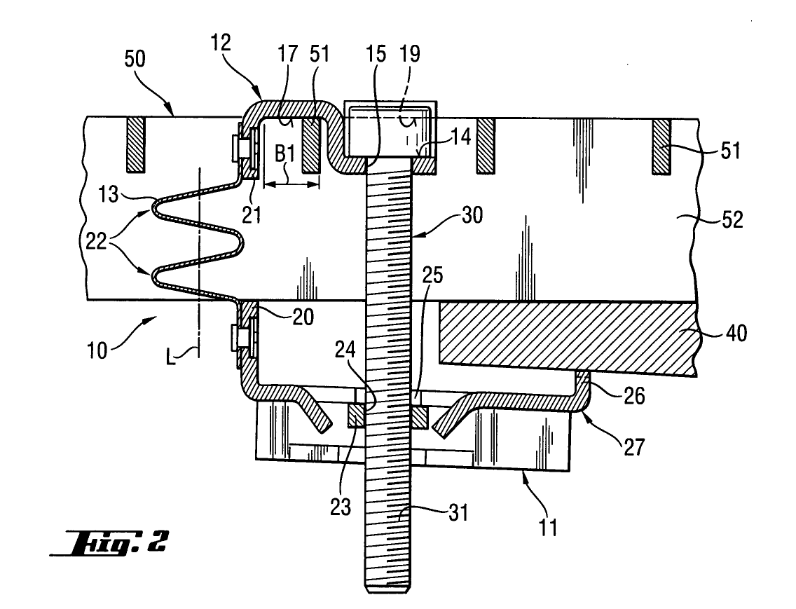

FIGS. 1-2 show a holding element 10 according to the present invention for securing gratings 50 on supports 40, among others, of a grillage. The holding element 10 is formed of several parts and has essentially a U-shaped cross-section. The holding element 10 has a first leg-shaped engagement part 11 for a support 40 and a second engagement part 12 or a holding part for a grating 50, with both parts extending from a connection section that connects the engagement parts 11 and 12 with each other and is formed as a spring element 13 in form of wavy leaf spring formed of several waves 22. Both engagement parts 11, 12 are spaced from each other along a longitudinal axis L, which is defined by the connection section or spring element 13. Both engagement parts are formed as relatively deflection-resistant parts. The spring element 13 is formed as a separate component secured with one of its ends to a first connection region 20 of the first engagement part 11 and with another of its ends to a second connection region 21 of the second engagement part 12. Both connection regions 20, 21 likewise extend in the longitudinal direction of the axis L. The ends of the connection section can be secured to respective connection regions 20, 21 by soldering or welding, forcelockingly by a clamp connection, or by a formlocking connection.

The second engagement part 12 has a recess 14 with an opening 15 and an abutment for screw means 30. The second engagement part 12 further has on three sides which surround the opening 15 and are arranged transverse to each other, respectively, bracket-shaped first, second and third bearing regions 17, 18, 19 which engage, in a mounted condition of the holding element 10, cross-struts 51 and/or longitudinal struts 52 of the grating (see FIG. 2). The bracket-shaped bearing regions 17, 18, 19 have, in the embodiment discussed here, different widths B1, B2, B3, which insures an easy mounting on gratings having different mesh sizes. A relatively large width B1 of the first bearing region 17 allows displacement of the holding element 10 over the grating 50 for a precise positioning.

The first engagement part has a hole 25 located opposite the opening 15 in the second engagement part 12 on which there is arranged a nut 23 with a counter-thread 24 in which the screw means 30 can engage with its thread 31 (see FIG. 2). Further, the first engagement part 11 has a U-shaped cross-section for stiffening the holding element 10.

At its end region 27 remote from the spring element 13, the first engagement part 11 has holding means 26 in form of teeth facing toward the second engagement part 12. The first engagement part 11 projects in the direction of a leg longitudinal axis S beyond the second engagement part 12.

In the connection region 20 of the first engagement part 11, there is formed, with respect to the leg longitudinal axis S and the longitudinal axis L, a projection 16 that projects sidewise from the first engagement part 11 and forms, in a mounted condition of the holding element 10, a stop for the lower side of a strut of the grating 50.

Upon mounting of the inventive holding element 10, firstly, it is pivoted with its first engagement part 11 and the connection section or the spring element 13 through an opening between two cross-struts 51 of the grating 50 (not shown in the drawings), so that the first engagement part 11 is positioned, together with its holding means 26, under a support 40. The spring element 13 would, as necessary, expand or compress until the holding element 10 is adapted to the grating height. The spring element 13 can be compressed at a small grating height. The spring element 13 can expand, in its longitudinal direction along the axis L at least by 150%, preferably, up to 200% of its initial length A and be compressed up to 50% of its initial length A. The spring element 13 is also resiliently displaceable in the direction of the leg longitudinal axis S. Within the meaning of the invention, the initial length A is the length of the spring element 13 in a condition when the holding element 10, as shown in FIG. 1, is not yet mounted or is not subjected to any manipulation and, in particular, has not yet been lengthened or upset.

After the holding element 10 has been arranged on the grating 50 and the support 40, the projection 16, which serves as a stop, lies on a side of a longitudinal strut 52 of the grating 50 remote form the second engagement part 12. The projection 16 lies on a projection of the third bearing region 19. This insures that in each case, the projection 16 lies beneath a strut of the grating 50.

By screwing the screw means 30, which extends through the opening 15, with its thread 31 in the counter-thread 24 of the nut 23, the holding element 10 is fixed. As shown in FIG. 2, in the mounted condition of the holding element 10, the bracket-shaped regions 17, 18, 19 of the second engagement part 12 lie on cross-strut 51 and longitudinal struts 52 of the grating 50. The projection 16 clampingly engages a longitudinal strut 52 of the grating 50. The first engagement part 11 engages, as it has already been discussed before, with its holding means 26, which is provided in its end region 27, the bottom of the support 40, digging thereunto. This insures a reliable retention of the grating 50 on the support 40. As a result of the screw means 30 being screwed in, the spring element 13 is upset by about 75% of its original or initial length shown in FIG. 1.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A holding element for securing gratings (50) to supports (40), comprising a first leg-shaped engagement part (11); a second engagement part (12); and a connection section for connecting the first (11) and the second (12) engagement parts, the first and second engagement parts (11, 12) projecting from the connection section and being spaced from each other along a longitudinal axis (L) of the connection section, and the connection section being formed, at least partially, of a spring element (13) elastically expandable in a direction of the longitudinal axis (L) of the connection section by up to 150% of an initial length (A) thereof.

2. A holding element according to claim 1, wherein the spring element (13) has opposite ends secured to first and second connection regions (20, 21) of the respectively, first and second engagement parts (11, 12).

3. A holding element according to claim 1, wherein the spring element (13) is elastically compressible from the initial length A thereof.

4. A holding element according to claim 1, wherein the spring element (13) is expandable in the directions of the longitudinal axis (L) of the connection section thereof by up to 200% of the initial length (A) thereof.

5. A holding element according to claim 3, wherein the spring element (13) is compressible in the direction of the longitudinal axis (L) of the connection section by up to 50% of the initial length (A) thereof.

6. A holding element according to claim 1, wherein the spring element (13) is formed as a wavy leaf spring.

7. A holding element according to claim 6, wherein the wavy leaf spring is formed of at least two waves (22).

8. A holding element according to claim 1, wherein the spring element (13) is deflection-resistant in a direction transverse to the longitudinal axis (L) of the connection section and transverse to a longitudinal axis of the leg-shaped first engagement part (11).

9. A holding element according to claim 1, wherein the second engagement part (12) has an opening (15) with an abutment for screw means (30), and the first engagement part (11) has a counter-thread (24) for a thread (31) of the screw means (30), and holding means (26) for securing the holding element (10) on a support (40) and facing in a direction toward the second engagement part (12).

10. A holding element according to claim 1, wherein the first leg-shaped engagement part (11) has a projection (16) formed thereon and extending sidewise of a longitudinal axis (S) of the first leg-shaped engagement part (11) and sidewise of the longitudinal axis (L) of the connection section.
